(19) United States
(12) Patent Application Publication
(10) Pub. No.: US 2012/0314872 A1
(43) Pub. Date: Dec. 13, 2012

(54) SYSTEM AND METHOD FOR PROCESSING AN INPUT SIGNAL TO PRODUCE 3D AUDIO EFFECTS

(76) Inventors: Ee Leng Tan, Singapore (SG); Woon Seng Gan, Singapore (SG)

(21) Appl. No.: 13/516,898

(22) PCT Filed: Jan. 19, 2011
(86) PCT No.: PCT/SG11/00027

§ 371 Date: Jun. 18, 2012

Related U.S. Application Data
(60) Provisional application No. 61/296,187, filed on Jan. 19, 2010.

(51) Int. Cl. H04R 5/00

(52) U.S. Cl. 381/17

(57) ABSTRACT

A processing system for processing an input signal to produce three-dimensional audio effects is disclosed. The processing system comprises: a cue sending path configured to extract a set of binaural cues from the input signal and further configured to send at least a portion of the extracted set of binaural cues to at least one directional loudspeaker for transmission; and an ambience sending path configured to send at least a part of the input signal comprising ambience sounds to at least one conventional loudspeaker for transmission.

### FIELD OF THE INVENTION

The present invention relates to a method and a processing system for processing an input signal to produce three-dimensional (3D) audio effects. The processing system may be coupled with a plurality of loudspeakers to form an audio system for producing the 3D audio effects.

### BACKGROUND OF THE INVENTION

3D visual content is readily available, for example, in 3D games, 3D movies and 3D TV broadcast. To create a convincing 3D environment, the viewer of the 3D visual content should preferably be able to experience and feel a certain sense of spaciousness (for example, the spaciousness of a typical forest when the viewer is “in” a virtual forest). Preferably, there should be accompanying 3D audio effects that are matched with the 3D visual content, for example, as the viewer is “walking through” the virtual forest. More preferably, the viewer should be able to experience different depths of the audio content.

FIG. 1 illustrates an example of matching 3D visual and audio content. In FIG. 1, the 3D visual content (which may be from a 3D TV show, 3D game or 3D movie) comprises images of a bee flying around a viewer in a grass field. The audio content comprises sounds in the grass field (in the form of far sounds) so that the viewer is able to experience the ambience of the grass field. The audio content further comprises sounds from the bee (in the form of near sounds which may comprise binaural cues) so that the viewer is able to feel the proximity of the bee.

3D games usually place the player's avatar in the middle of the action, regardless of whether they are 1^{st} person shooter games or 3^{rd} person shooter games. To enhance the realism of the gaming experience, 3D sounds are often used extensively with 3D graphics in 3D games. The audio content in a 3D game generally comprises a soundtrack, which in turn comprises ambience sounds and sound effects embedded with audio (or binaural) cues to enhance the realism of the game. For example, the audio content may comprise ambience sounds of a typical room or forest which may be used when the player's avatar is in a virtual room or forest and 3D audio cues reflecting sounds of bullets flying towards the player's avatar. The sound effects in 3D games are usually processed with 3D audio techniques such as Direct Sound in Windows, allowing game developers to position the sound effects almost anywhere in a virtual space surrounding the player, hence adding another dimension of realism into the games.

Other than gaming applications, there are many other applications in which it is highly desirable to create an auditory experience which allows the user (or listener) to feel that he or she is indeed in a particular environment. Creating such an immersive experience requires that the audio, sounds presented to the user provide a certain level of spaciousness and envelopment. The level of spaciousness refers to the extent of space portrayed to the user and may be expressed as the direct sound to reflections and reverberation ratio. Spaciousness may be achieved using a two-channel (stereo) or a multi-channel (more than two channels) system, although for a two-channel system, the spaciousness and depth dimension of the audio content are usually constrained by the space between the two conventional loudspeakers used in the system. On the other hand, envelopment i.e. the sensation of being surrounded by sound is usually only achievable using a multi-channel system. The level of envelopment is usually dependent on the number of loudspeakers in the system and the spacing between these loudspeakers.

As shown in the above examples, both visual and audio cues play important roles in 3D media such as 3D TV broadcast, 3D games and 3D movies. Unfortunately, due to the limitation of conventional loudspeakers, it remains difficult to achieve immersive sounds for 3D media using current audio systems.

Although setting up surround loudspeakers in a multi-channel system may achieve 3D audio effects, this may be problematic in an environment with limited space. In such an environment, a two-channel system is more attractive but its use is usually at the expense of a smaller sound field. Furthermore, head related transfer functions (HRTFs) are often required to approximate a desired multi-channel sound using a two-channel system. Without personalized HRTFs, there may be problems such as in-head localization and front-back confusion. In addition, using a two-channel system to approximate a multi-channel sound requires good crosstalk cancellation. This limits the performance of this approach since crosstalk cancellation usually requires a good subtraction of two sound fields and tends to be very sensitive to system variations or errors. Moreover, such an approach is sweet spot dependent. Although it may be possible to overcome these problems (i.e. the sweet spot dependency and the need for crosstalk cancellation) by using headphones, this solution is not without issues. For example, discomfort and fatigue may arise after prolonged use of headphones.

Virtual surround sound systems (VSSS) using 3D sound techniques and conventional loudspeakers to create a virtual audio/sound image (i.e. audio/sound effects) have also been developed. However, there is usually a lack of auditory depth in the audio effects produced using such virtual systems. Furthermore, similar to systems which require the use of HRTFs, VSSS are generally sweet spot dependent.

### SUMMARY OF THE INVENTION

The present invention aims to provide a new and useful processing system and method for processing an input signal to produce 3D audio effects. The processing system may be integrated with a plurality of loudspeakers to form an audio system for producing the 3D audio effects. It may also be integrated with a device for generating or capturing audio signals.

In general terms, the present invention proposes a processing system configured to transmit a first group of components in the input signal to at least one directional loudspeaker and a second group of components in the input signal to at least one conventional loudspeaker. A conventional loudspeaker is defined in this document as a loudspeaker configured to produce a wide dispersion of sound (by “wide”, it is meant that the angle of dispersion of the sound from a conventional loudspeaker is more than 30 degrees) whereas a directional loudspeaker is defined in this document as a loudspeaker configured to produce a directional sound beam (by “directional”, it is meant that the angle of dispersion of the sound from a directional loudspeaker is less than 30 degrees). Furthermore, the directional loudspeaker is typically a parametric loudspeaker generating a modulated ultra-sonic wave, whereas the conventional loudspeaker(s) does not typically generate a modulated ultrasonic beam.

More specifically, a first aspect of the present invention is a processing system for processing an input signal to produce three-dimensional audio effects, the processing system comprising: a cue sending path configured to extract a set of binaural cues from the input signal and further configured to send at least a portion of the extracted set of binaural cues to at least one directional loudspeaker for transmission; and an ambience sending path configured to send at least a part of the input signal comprising ambience sounds to at least one conventional loudspeaker for transmission.

A second aspect of the present invention is a method for processing an input signal to produce three-dimensional audio effects, the method comprising the steps of: extracting a set of binaural cues from the input signal and sending at least a portion of the extracted set of binaural cues to at least one directional loudspeaker for transmission; and sending at least a part of the input signal comprising ambience sounds to at least one conventional loudspeaker for transmission.

The present invention is advantageous as it exploits the directivity of directional loudspeakers and the wide dispersive characteristic of conventional loudspeakers. The dispersive nature of the conventional loudspeakers helps to recreate a certain degree of spaciousness and envelopment whereas the directional loudspeakers are not only useful for 3D sound projection, they can also achieve sharper and more vivid auditory spatial images. The directional loudspeakers are also capable of bringing these auditory images closer to the users. Thus, using at least one directional loudspeaker for transmitting a portion of a set of binaural cues extracted from the input signal and using at least one conventional loudspeaker for transmitting a part of the input signal comprising ambience sounds helps to create a highly-focused sound image comprising vivid auditory images close to the users while still projecting the background audio image to the users.

### BRIEF DESCRIPTION OF THE FIGURES

An embodiment of the invention will now be illustrated for the sake of example only with reference to the following drawings, in which:

FIG. 1 illustrates an example of matching 3D visual and audio content;

FIG. 2 illustrates an audio system according to an embodiment of the present invention, the audio system comprising a processing system;

FIG. 3 illustrates a block diagram showing an example of using a multi-channel approach in a cue sending path of the processing system in FIG. 2;

FIG. 4 illustrates a block diagram showing an example of using a multi-channel approach in an ambience sending path of the processing system in FIG. 2, the block diagram further showing an example of down-mixing a part of an input signal of the processing system of FIG. 2;

FIG. 5 illustrates a parametric loudspeaker system according to a first prior art;

FIG. 6 illustrates a parametric loudspeaker system according to a second prior art;

FIG. 7 illustrates a block diagram showing a MAM technique used in the processing system of FIG. 2;

FIG. 8 illustrates a block diagram showing an example of using a sub-band approach in a cue sending path of the processing system in FIG. 2;

FIGS. 9(a)-(d) illustrate different examples of how the processing system of FIG. 2 may be integrated with different systems having different loudspeaker configurations;

FIG. 10 illustrates an example setup of video displays, conventional loudspeakers and directional loudspeakers whereby the loudspeakers may be coupled with the processing system of FIG. 2;

FIG. 11 illustrates a prior art system which uses directional loudspeakers to create virtual loudspeakers to replace surround loudspeakers;

FIGS. 12(a)-(b) illustrate audio images produced by loudspeakers having different directivities; and

FIGS. 13(a)-(b) illustrates examples of soundscapes that may be achieved by the audio system of FIG. 2.

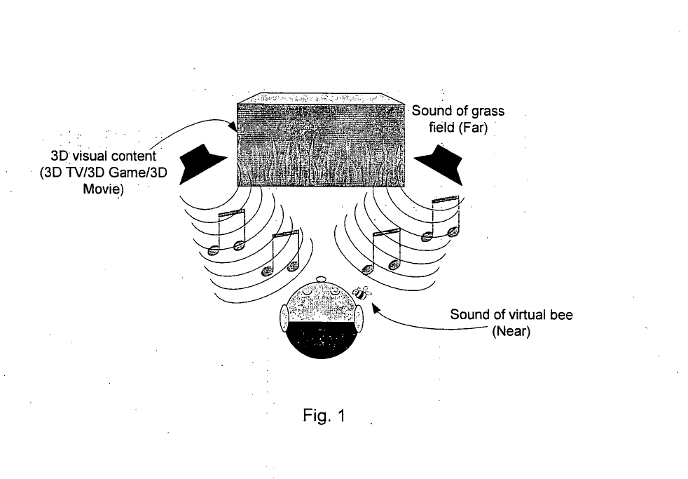

### DETAILED DESCRIPTION OF THE EMBODIMENTS

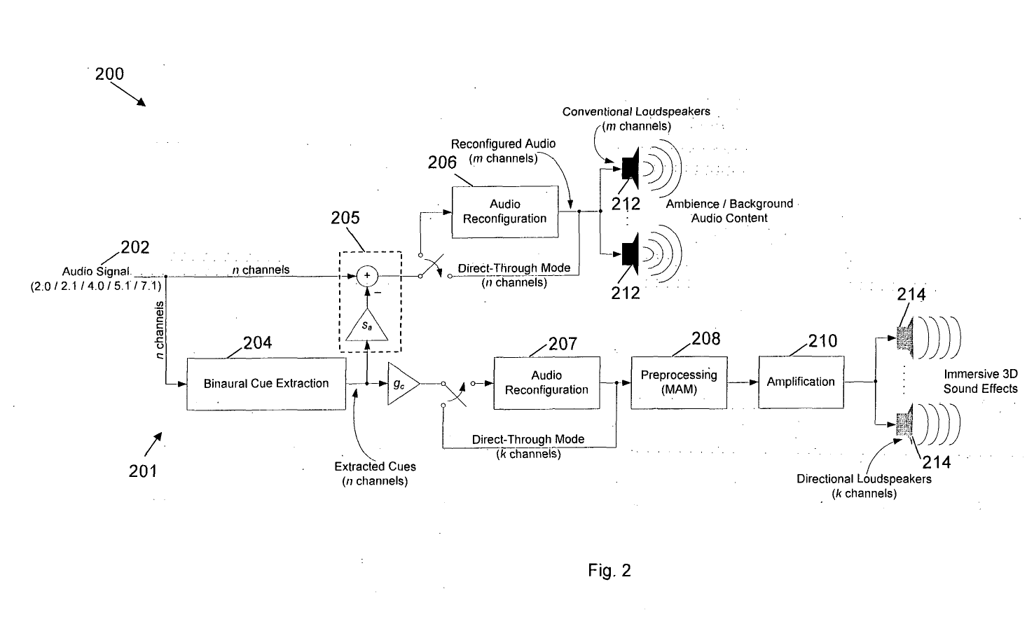

FIG. 2 illustrates an audio system 200 (or Augmented Audio System (AAS)) according to an embodiment of the present invention.

The audio system 200 serves to produce 3D audio effects. As shown in FIG. 2, the system 200 comprises a processing system 201 for processing an input signal 202 to produce the 3D audio effects. The input signal 202 may comprise an audio signal. The audio system 200 also comprises a plurality of conventional loudspeakers 212 (which may be loudspeakers belonging to a 2.0, 2.1, 4.0, 5.1 and/or 7.1 speaker configuration) and a plurality of directional loudspeakers 214. In FIG. 2, the system 200 comprises a total of m conventional loudspeakers 212 and k directional loudspeakers 214.

The different components of the audio system 200 will now be described in more detail.

The processing system 201 comprises a cue sending path and an ambience sending path. These paths comprise front-end digital audio processing blocks which serve to pre-process the input signal 202.

The cue sending path comprises a cue extraction module in the form of a binaural cue extraction module 204 and is configured to extract a set of binaural cues from the input signal 202 using this binaural cue extraction module 204. The extracted set of binaural cues may comprise only a single binaural cue and may be used to synthesize audio effects. The cue sending path is further configured to send at least a portion, if not the whole, of the extracted set of binaural cues to at least one directional loudspeaker 214 for transmission. This portion of the extracted set of binaural cues to be sent to the at least one directional loudspeaker 214 may be adjusted using a variable g_{c} as shown in FIG. 2 where 0<g_{c}≦1.

As shown in FIG. 2, the cue sending path in the processing system 201 is operable in two modes: the reconfiguration mode and the direct-through mode. The choice of which mode to use usually depends on the configuration of the input signal 202 and the configuration of the directional loudspeakers 214 to be used for transmitting the portion of the extracted set of binaural cues.

In the direct-through mode, the cue sending path is configured to send the portion of the extracted set of binaural cues directly to the directional loudspeakers 214. This mode is usually used when the configuration of the input signal 202 (and hence, the extracted set of binaural cues) matches the configuration of the directional loudspeakers 214 to be used.

On the other hand, the reconfiguration mode is usually used when the configuration of the input signal 202 does not match the configuration of the directional loudspeakers 214 to be used. The cue sending path comprises a reconfiguration module in the form of an Audio Reconfiguration (AR) module 207. This AR module 207 serves to reconfigure the portion of the extracted set of binaural cues to be sent to the directional loudspeakers 214, so as to match the configuration of the directional loudspeakers 214 to be used. For example, if the number of channels in the portion of the extracted set of binaural cues is not the same as the number of directional loudspeakers 214 to be used for transmitting the binaural cues, the AR module 207 is operable to reconfigure this portion of the extracted set of binaural cues by up-mixing or down-mixing it.

If the input signal 202 comprises a plurality of channels, at least a part of the cue sending path may be configured to process each channel of the input signal 202 independently. For example, the binaural cue extraction module 204 may be configured to extract a group of binaural cues from each channel in the input signal 202. Alternatively, binaural cues may be extracted from only a subset of (i.e. not all) the channels in the input signal 202 whereby a group of binaural cues is extracted from each channel in this subset. The cue sending path may be further configured to send at least a portion of each extracted group of binaural cues to the directional loudspeakers 214 for transmission. The portion of each extracted group of binaural cues to be sent to the directional loudspeakers 214 may be adjusted independently (in one example, this portion may range from zero to one (not inclusive of zero)).

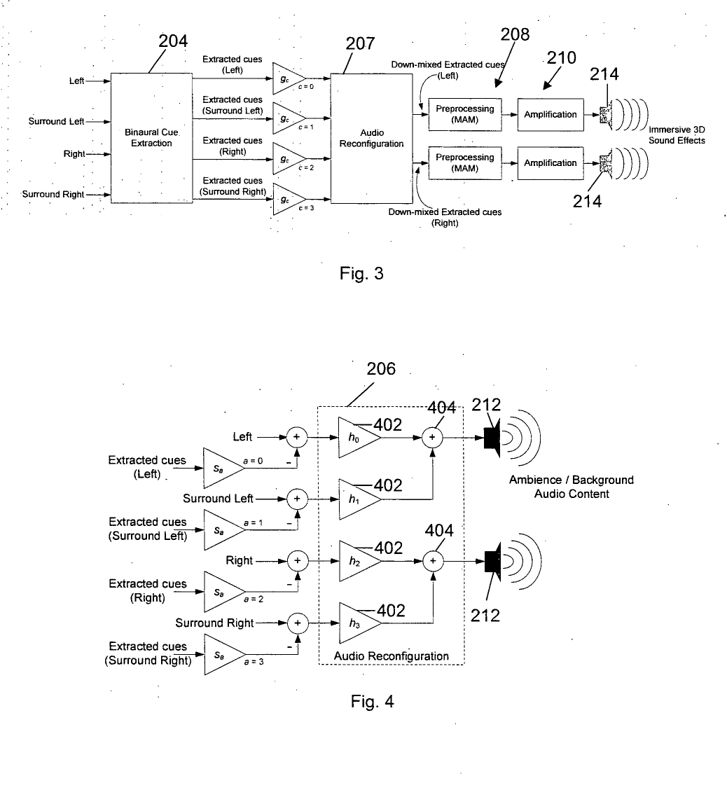

FIG. 3 illustrates an example of the multi-channel approach described above. In FIG. 3, the input signal 202 comprises four channels (left, surround left, right, surround right). Binaural cues are extracted from all four channels and these extracted binaural cues are then down-mixed to two output channels (left and right). As shown in FIG. 3, the cue sending path is configured to send a portion of each extracted group of binaural cues to the AR module 207 for reconfiguration and then to the directional loudspeakers 214 for transmission. Each of these portions may be adjusted independently using the respective variable g_{c} where c=0 denotes the left channel, c=1 denotes the surround left channel, c=2 denotes the right channel and c=3 denotes the surround right channel. In other words, g₀, g₁, g₂ and g₃ may or may not take the same values. The AR module 207 is configured to down-mix the binaural cues from the left and surround left channels to form the left output channel (shown as “Down-mixed Extracted cues (Left)” in FIG. 3) and the binaural cues from the right and surround right channels to form the right output channel (shown as “Down-mixed Extracted cues (Right) in FIG. 3). Each of the left and right output channels is then sent to a respective directional loudspeaker 214. Note that since the extracted binaural cues may be down-mixed (if n<k) or up-mixed (if n>k) to match the number of directional loudspeakers 214, the number of channels from which the binaural cues are extracted need not be the same as the number of directional loudspeakers 214 to be used (i.e. it is possible for n≠k). Alternatively, the processing system 201 may be configured such that the number of channels from which binaural cues are extracted equals the number of directional loudspeakers 214 to be used. In this alternative, no reconfiguration of the extracted binaural cues is required. Furthermore, in this alternative, a portion from each extracted group of binaural cues may be sent to a respective directional loudspeaker 214 for transmission.

The cue sending path of system 201 further comprises a pre-processing module 208 and an amplification module 210 which serve to modulate and amplify the portion of the extracted set of binaural cues (which may comprise portions of different groups of binaural cues extracted from different channels) before sending it to the directional loudspeakers 214 for transmission. In one example, the pre-processing module 208 is configured to modulate the portion of the extracted set of binaural cues onto an ultrasonic carrier signal using a Modified Amplitude Modulation (MAM) technique. The MAM technique is discussed in more detail below and in PCT Patent Application No. PCT/SG2010/000312, the contents of which are herein incorporated by reference. The portion of the extracted set of binaural cues is then amplified in the amplification module 210 before it is sent to the directional loudspeakers 214 for transmission. Note that different channels of the input signal 202 may also be independently processed through the pre-processing module 208 and the amplification module 210.

The ambience sending path of processing system 201 in FIG. 2 is configured to send at least a part, if not the whole, of the input signal 202 comprising ambience sounds to at least one conventional loudspeaker 212 for transmission. In one example, to extract the part of the input signal 202 comprising ambience sounds, the ambience sending path comprises an ambience extraction unit 205 configured to subtract from the input signal 202 at least a portion of the set of binaural cues extracted using the binaural cue extraction module 204. Alternatively, the ambience extraction unit 205 may be configured to not subtract any extracted binaural cue from the input signal 202. In other words, the whole of the input signal 202 may be sent to the at least one conventional loudspeaker 212 for transmission. The portion of the extracted set of binaural cues to be subtracted from the input signal 202 may be adjusted using a variable sₐ (where 0≦sₐ≦1) as shown in FIG. 2

In one example, the conventional loudspeakers 212 comprise surround loudspeakers and non-surround loudspeakers. In this example, the ambience sending path is configured to send at least a portion of the set of binaural cues extracted using the binaural cue extraction module 204 to the surround loudspeakers for transmission. These binaural cues may be distributed accordingly among the surround loudspeakers. In this example, the ambience sending path is further configured to send the part of the input signal 202 comprising ambience sounds to the non-surround loudspeakers for transmission.

In another example, the conventional loudspeakers 212 do not comprise any surround loudspeaker and the ambience sending path is configured to send the part of the input signal 202 comprising ambience sounds to all the conventional loudspeakers 212 for transmission. This part of the input signal 202 may be distributed accordingly among the conventional loudspeakers 212.

If the input signal 202 comprises a plurality of channels, at least a part of the ambience sending path may be configured to process each channel of the input signal 202 independently. For example, the ambience extraction unit 205 may be configured to subtract from each channel in the input signal 202, at least a portion of a group of binaural cues extracted from the channel. Alternatively, this subtraction may be performed for only a subset of (i.e. not all) the channels in the input signal 202. The portion of each group of binaural cues to be subtracted from the respective channel in the input signal 202 may be adjusted independently (in one example, this portion may range from zero to one (inclusive of zero)). Note that if this portion is zero for a particular channel, it implies that the subtraction is not performed for the channel i.e. the whole of this channel is sent to the at least one conventional loudspeaker 212 for transmission.

FIG. 4 illustrates an example of the multi-channel approach described above (FIG. 4 also illustrates the down-mixing of a part of the multi-channel input signal 202 to two output channels and this will be elaborated later.). In FIG. 4, the input signal 202 comprises four channels (left, surround left, right, surround right) and binaural cues are subtracted from all the four channels. As shown in FIG. 4, a portion of the group of binaural cues extracted from each channel is subtracted from the respective channel of the input signal 202. Each of these portions may be adjusted independently using the respective variable sₐ where a=0 denotes the left channel, a=1 denotes the surround left channel, a=2 denotes the right channel and a=3 denotes the surround right channel. In other words, different values can be used for s₀, s₁, s₂ and s₃. Note that the input signal 202 need not comprise only four channels (for example, the input signal may comprise n channels and a=0, 1, 2, . . . , n−1 may be used to respectively denote each channel).

To accommodate different user requirements, the ambience sending path in the processing system 201 is also operable in two modes: the reconfiguration mode and the direct-through mode. The choice of which mode to use usually depends on the configuration of the input signal 202 and the configuration of the conventional loudspeakers 212.

In the direct-through mode, the ambience sending path is configured to send the extracted part of the input signal 202 comprising ambience sounds directly to the conventional loudspeakers 212. This mode is usually used when the configuration of the input signal 202 (and hence, the extracted part of the input signal 202 comprising ambience sounds) matches the configuration of the conventional loudspeakers 212 to be used for transmitting the extracted part of the input signal 202, for example, when the number of channels n in the input signal 202 is equal to the number of conventional loudspeakers 212 (i.e. n=m) and all the conventional loudspeakers 212 are used for transmitting the extracted part of the input signal 202.

On the other hand, the reconfiguration mode is usually used when the configuration of the input signal 202 does not match the configuration of the conventional loudspeakers 212 to be used for transmitting the extracted part of the input signal 202 (for example, when m≠n). In the reconfiguration mode, the ambience sending path is operable to reconfigure the extracted part of the input signal 202 comprising ambience sounds to match the configuration of the conventional loudspeakers 212 to be used. The ambience sending path comprises a reconfiguration module in the form of an Audio Reconfiguration (AR) module 206 for this purpose. In other words, the AR module 206 is operable to reconfigure the extracted part of the input signal 202 comprising ambience sounds to match the configuration of the conventional loudspeakers 212 to be used. For example, if m≠n (and all m conventional loudspeakers are to be used for transmitting the extracted part of the input signal 202), the AR module 206 serves to reconfigure the extracted part of the input signal 202 by up-mixing or down-mixing it. More specifically, if the input signal 202 is configured for a 5.1 speaker configuration and the conventional loudspeakers 212 belong to a 7.1 speaker configuration (i.e. (n=6)<(m=8)), the extracted part of the input signal 202 may be up-mixed using the AR module 206. Alternatively, if the input signal 202 is configured for a 5.1 speaker configuration and the conventional loudspeakers 212 belong to a 2.1 speaker configuration (i.e. (n=6)>(m=3)), the extracted part of the input signal 202 may be down-mixed using the AR module 206.

If the conventional loudspeakers 212 comprise surround and non-surround loudspeakers as in one of the examples mentioned above, the AR module 206 may be operable to reconfigure the portion of the set of binaural cues to be sent to the surround loudspeakers to match the configuration of the surround loudspeakers. In this case, the part of the input signal 202 comprising ambience sounds may be reconfigured using the AR module 206 to match the configuration of the non-surround loudspeakers.

As mentioned above, FIG. 4 illustrates an example of down-mixing a part of the input signal 202. In FIG. 4, the input signal 202 comprises four channels. However, only two conventional loudspeakers 212 forming a stereo system are to be used for transmitting the extracted part of the input signal 202. Hence, after subtracting the binaural cues from the respective channels, the extracted part, of the input signal 202 is down-mixed by a mixing network in the AR module 206. This mixing network comprises a plurality of weighting elements 402 (having values h₀, h₁, h₂, h₃ where 0≦h₀, h₁, h₂, h₃≦1) and a plurality of adders 404 for implementing two weighted combinations. Each weighting element 402 is configured to weight a channel of the extracted part of the input signal 202 whereas each adder 404 is configured to sum two weighted channels of the extracted part of the input signal 202. The sum from each adder 404 is then sent to a respective conventional loudspeaker 212 for transmission. Note that there may be only one or more than one adder 404 in the mixing network and each adder 404 may be configured to sum more than two weighted channels of the extracted part of the input signal 202. In addition, the AR module 206 may comprise other types of mixing networks for up-mixing or down-mixing the extracted part of the input signal 202.

### MAM Technique

As mentioned above, each of the directional loudspeakers 214 is configured to transmit a signal comprising modulated and amplified binaural cues. As this signal is radiated into a transmission medium (usually, air), it interacts with the transmission medium and self-demodulates to generate a tight column of audible signal. An audible sound beam is thus generated in the transmission medium through a column of virtual audible sources.

The Berktay far-field model as shown in Equation (1) may be used to approximate the above nonlinear sound propagation through the transmission medium. According to Equation (1), the demodulated signal (or audible difference frequency) pressure p₂(t) along the axis of propagation is proportional to the second time-derivative of the square of the envelope of the modulated signal (i.e. the signal comprising the modulated and amplified binaural cues). In Equation (1), β is the coefficient of nonlinearity, P₀ is the primary wave pressure, α is the radius of the ultrasonic emitter comprised in the directional loudspeaker 214, ρ₀ is the density of the transmission medium, c₀ is the small signal sound speed, z is the axial distance from the ultrasonic emitter, α₀ is the attenuation coefficient at the source frequency and E(t) is the envelope of the modulated signal.

$$\begin{matrix}{p}_{2} ( t ) \approx \frac{β {P}_{0}^{2} {a}^{2}}{16 {ρ}_{0} {c}_{0}^{4} z {α}_{0}} \frac{{d}^{2}}{d {t}^{2}} {E}^{2} ( t ) \\ ∝ \frac{d}{d {t}^{2}} {E}^{2} ( t )\end{matrix} \qquad ( 1 )$$

As shown in Equation (1), the nonlinear sound propagation results in a distortion in the demodulated signal p₂(t). This in turn results in a distortion in the audible signal generated.

The following is a discussion of some prior attempts to reduce the above-mentioned distortion in the demodulated signal. This is followed by an elaboration of the MAM technique which also serves to reduce the above-mentioned distortion.

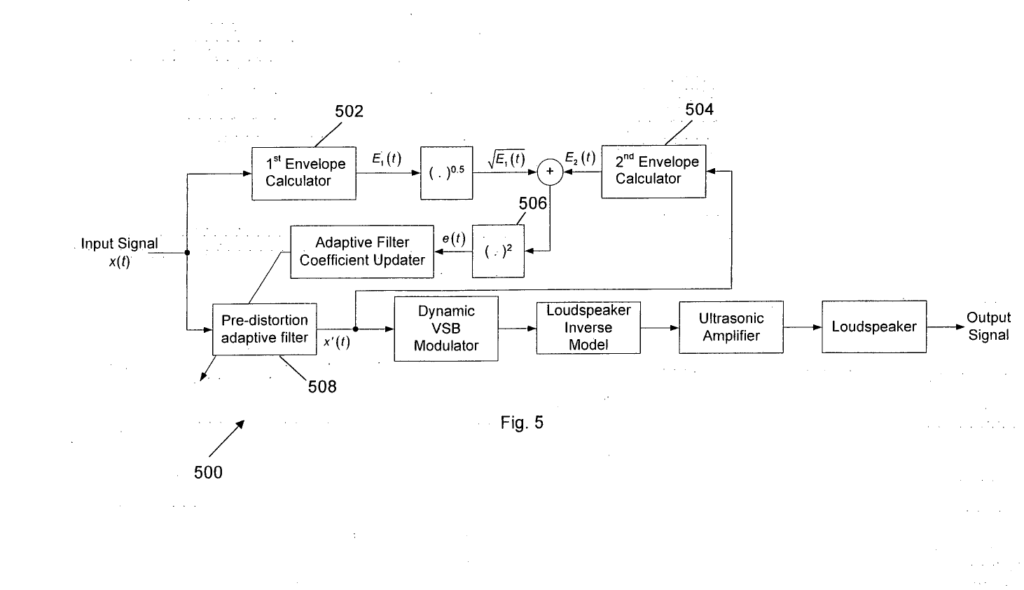

FIG. 5 shows an adaptive parametric loudspeaker system 500 proposed in U.S. patent application Ser. No. 11/558,489 “Ultra directional speaker system and signal processing method thereof” (hereinafter, Kyungmin). Kyungmin proposes adaptively applying pre-distortion compensation to the modulating signal x(t) (i.e. the input signal). Furthermore, instead of using a double sided amplitude modulation (DSBAM) scheme typically used in parametric loudspeaker systems, Kyungmin proposes using vestigial sideband modulation (VSB) to overcome the non-ideal filtering of one of the sidebands in single sideband (SSB) modulation.

As shown in FIG. 5, the adaptive parametric loudspeaker system 500 comprises 1^{st} and 2^{nd} envelope calculators 502, 504 which calculate the envelopes E₁(t) and E₂(t) respectively. These envelope calculators 502, 504 are injected with signals at the baseband. The adaptive parametric loudspeaker system 500 also comprises a square root operator 506 which computes the “ideal” envelope \sqrt{E₁(t)} predicted using Berktay's approximation (as shown in Equation (1)).

The difference between \sqrt{E₁(t)} and E₂(t) is then used to train the pre-distortion adaptive filter 508 using the least mean square (LMS) scheme. The coefficients aₘ of the adaptive filter 508 are obtained using Equations (2) and (3) as follows wherein β is an adaptive coefficient.

αₘ′(t)=−2(\sqrt{E₁(t)}−E₂(t))x(t−m) (2)

αₘ(t+1)=αₘ(t)+βαₘ′(t) (3)

The output x′(t) of the adaptive filter 508 is shown in Equation (4) as follows.

$${x}^{′} ( t ) = {\sum }_{m = 0}^{N - 1} {a}_{m} ( t ) x ( t - m ) \qquad ( 4 )$$

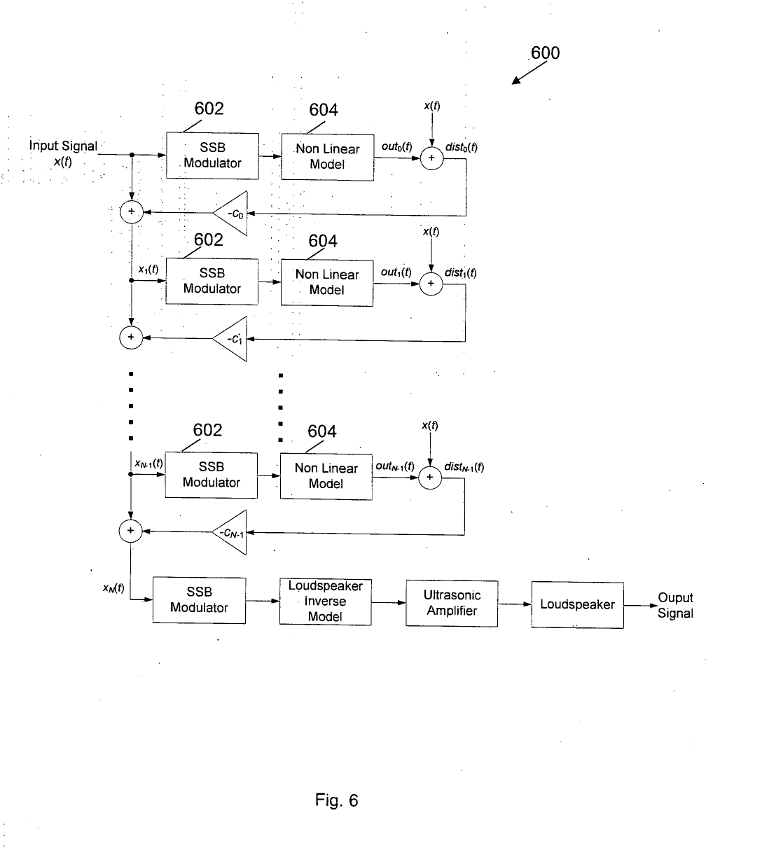

FIG. 6 illustrates a parametric loudspeaker system 600 proposed in U.S. Pat. No. 6,584,205 (hereinafter, Croft). Croft proposed the use of SSB modulation as it offers the same ideal linearity as characterized by square rooting a pre-processed DSBAM modulated signal. Croft further proposed compensating for the distortion inherent in SSB signals using a multi-order distortion compensator. The multi-order distortion compensator comprises a cascade of distortion compensators (Distortion compensator 0 . . . N−1 as shown in FIG. 6) whereby a pre-distorted signal (for example, x₁(t)) from one distortion compensator is used as the input to the next distortion compensator in the cascade and so on, until the desired order is reached. Each distortion compensator of Croft comprises a SSB modulator 602 which employs a conventional SSB modulation technique. Similar to Kyungmin, the non-linear models 604 shown in FIG. 6 are based on Berktay's approximation (i.e. Equation (1)) and the system 600 proposed in Croft is based on a feed forward structure found in the multi-order distortion compensator.

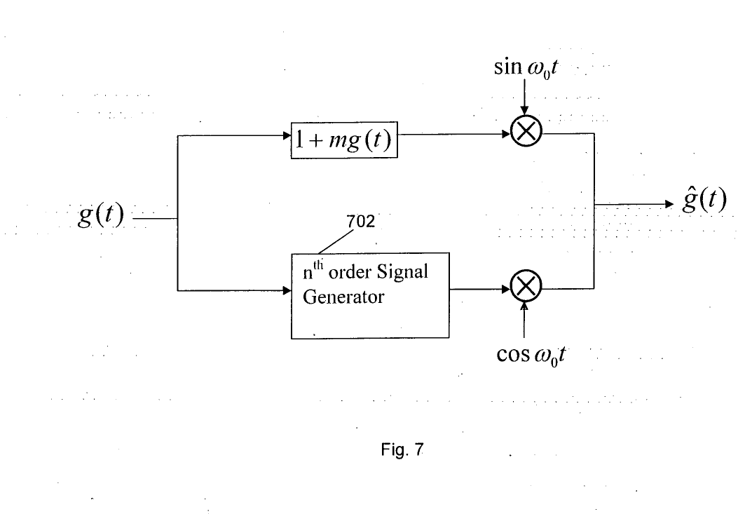

FIG. 7 illustrates the MAM technique which uses a pre-distortion term with a variable order. Equation (5) describes the output ĝ(t) of the modulation technique shown in FIG. 7 whereby g(t) is the input to the modulation technique, m is the modulation index and ω₀=2πf₀ where f₀ is the carrier frequency for the modulation.

$$\begin{matrix}\hat{g} ( t ) = ( 1 + mg ( t ) ) sin {ω}_{0} t + {\sum }_{i = 0}^{q} \frac{( 2 i ) !}{( 1 - 2 i ) {i !}^{2} {4}^{i}} {m}^{2 i} {g}^{2 i} ( t ) cos {ω}_{0} t \\ = \sqrt{{( 1 + mg ( t ) )}^{2} + {( {\sum }_{i = 0}^{q} \frac{( 2 i ) !}{( 1 - 2 i ) {i !}^{2} {4}^{i}} {m}^{2 i} {g}^{2 i} ( t ) )}^{2}} \\ sin [ {ω}_{0} t + {tan}^{- 1} ( \frac{{\sum }_{i = 0}^{q} \frac{( 2 i ) !}{( 1 - 2 i ) {i !}^{2} {4}^{i}} {m}^{2 i} {g}^{2 i} ( t )}{1 + mg ( t )} ) ]\end{matrix} \qquad ( 5 )$$

As shown in FIG. 7 and Equation (5), the modulation technique works by modulating the input g(t) with a first carrier signal sin ω₀t to produce a main signal (1+mg(t)) sin ω₀t, multiplying a pre-distortion term

$${\sum }_{i = 0}^{q} \frac{( 2 i ) !}{( 1 - 2 i ) {i !}^{2} {4}^{i}} {m}^{2 i} {g}^{2 i} ( t )$$

with a second carrier signal cos ω₀t to produce a compensation signal, and summing the main signal and the compensation signal to generate the output ĝ(t). Note that the first and second carrier signals are orthogonal to each other and that the pre-distortion term is generated by the signal generator 702 whereby the order of the signal generator 702 represents the order of the pre-distortion term it generates. From Equation (5), it can be seen that as compared to a typical DSBAM scheme which merely generates the main signal (1+mg(t))sin ω₀t, the output ĝ(t) comprises an additional orthogonal term

$${\sum }_{i = 0}^{q} \frac{( 2 i ) !}{( 1 - 2 i ) {i !}^{2} {4}^{i}} {m}^{2 i} {g}^{2 i} ( t ) cos {ω}_{0} t .$$

The additional pre-distortion term can help to reduce the distortion in the demodulated signal. This is elaborated below. Denoting f₁(t)=1+mg(t) and the output of the signal generator 702 as f₂(t), the output ĝ(t) of the MAM technique can be written in the form as shown in Equation (6).

ĝ(t)=f₁(t)sin ω₀t+f₂(t)cos ω₀t=\sqrt{f₁²(t)+f₂²(t)} sin [ω₀t+tan⁻¹(f₂(t)/f₁(t))] (6)

In other words, the envelope of the modulation technique output ĝ(t) is \sqrt{f₁²(t)+f₂²(t)}. According to the Berktay's approximation (Equation (1)), the demodulated signal (or audible difference frequency) pressure p₂(t) along the axis of propagation is proportional to the second time-derivative of the square of the envelope of the modulated signal. Substituting \sqrt{f₁²(t)+f₂²(t)} into Equation (1), Equation (7) is obtained as follows.

$$\begin{matrix}{p}_{2} ( t ) \approx \frac{β {P}_{0}^{2} {a}^{2}}{16 {ρ}_{0} {c}_{0}^{4} z {α}_{0}} \frac{{d}^{2}}{d {t}^{2}} {E}^{2} ( t ) \\ = \frac{β {P}_{0}^{2} {a}^{2}}{16 {ρ}_{0} {c}_{0}^{4} z {α}_{0}} \frac{{d}^{2}}{d {t}^{2}} {( \sqrt{{f}_{1}^{2} ( t ) + {f}_{2}^{2} ( t )} )}^{2}\end{matrix} \qquad ( 7 )$$

Setting f₂(t)=\sqrt{1−m²g²(t)}, Equation (7) can be written as follows:

$$\begin{matrix}{p}_{2} ( t ) \approx \frac{2 m β {P}_{0}^{2} {a}^{2}}{16 {ρ}_{0} {c}_{0}^{4} z {α}_{0}} \frac{{d}^{2}}{d {t}^{2}} ( g ( t ) ) \\ ∝ \frac{{d}^{2}}{d {t}^{2}} ( g ( t ) )\end{matrix} \qquad ( 8 )$$

As shown in Equation (8), by setting f₂(t)=\sqrt{1−m²g²(t)}, the demodulated signal becomes proportional to the input signal g(t). In other words, the distortion in the demodulated signal is completely removed. However, this is only true if and only if the directional loudspeaker 214 has infinite bandwidth. As this is not the case with practical loudspeakers, the pre-distortion term f₂(t)=\sqrt{1−m²g²(t)} is approximated using its truncated Taylor series

$${\sum }_{i = 0}^{q} \frac{( 2 i ) !}{( 1 - 2 i ) {i !}^{2} {4}^{i}} {m}^{2 i} {g}^{2 i} ( t ) .$$

By adjusting the value of q, the order of the pre-distortion term

$${\sum }_{i = 0}^{q} \frac{( 2 i ) !}{( 1 - 2 i ) {i !}^{2} {4}^{i}} {m}^{2 i} {g}^{2 i} ( t )$$

can be varied.

In the MAM technique, the amount of reduction in the distortion is dependent on the order of the pre-distortion term. A higher order will achieve a greater amount of reduction in the distortion. However, a higher order pre-distortion term requires a loudspeaker with a larger bandwidth. By using a pre-distortion term with a variable order, the flexibility of the modulation technique is increased and the order of the pre-distortion term may be varied to suit the requirements of the directional loudspeakers 214. For example, a lower order may be used for loudspeakers with smaller bandwidths whereas the order may be scaled up for loudspeakers with larger bandwidths to further reduce the distortion in the audio signal output of the audio system 200.

### Cue Extraction

The following are a few examples of how binaural cues may be extracted from the input signal 202 using the cue extraction module 204. These binaural cues may contain information to be simulated in the virtual environment, such as the azimuth between the listener and the virtual sound source, the angle of elevation between the listener and the virtual sound source and the distance between the listener and the virtual sound source.

In one example, the binaural cues are extracted by detecting and extracting transient events from the input signal 202. This may be performed in real-time or by post-processing a segment of the input signal 202. Furthermore, the detection and extraction of the transient events may be carried out in the time domain by repeatedly detecting an onset of (for example, an increase in) signal power in the input signal 202.

In another example, the binaural cues are extracted by performing a time-frequency transform in which components of the input signal 202 from a left channel, L, components of the input signal 202 from a right channel, R and a signal M whereby M=0.5 (L+R) are compared against each other. This method may be used to extract the binaural cues from the input signal 202 even if the input signal 202 is a multi-channel audio signal i.e. it comprises more than just the left and right channels. This is because the remaining channels in the input signal 202 are usually surround channels comprising mainly ambience sounds with no or very few binaural cues and thus may be ignored. However, more advanced techniques using more than two channels of the input signal 202 may be employed for the cue extraction.

Besides the two examples mentioned above, other techniques may be employed for the extraction of binaural cues from the input signal 202. For example, the binaural cues may be extracted using a short time Fourier Transform as described in reference [1].

### Sub-Band Approach

The audio system 200 may be implemented using a sub-band approach for an input signal 202 comprising a plurality of frequency bands. In the sub-band approach, at least a part of the cue sending path and/or the ambience sending path is configured to process each frequency band of the input signal 202 independently. For example, the cue extraction module 204 may use a time-frequency transform which can be implemented using a sub-band cue extraction algorithm. If the input signal 202 comprises a plurality of channels, and each channel of the input signal 202 comprises a plurality of frequency bands, at least a part of the cue sending path and/or ambience sending path may be configured to process each frequency band of each channel independently.

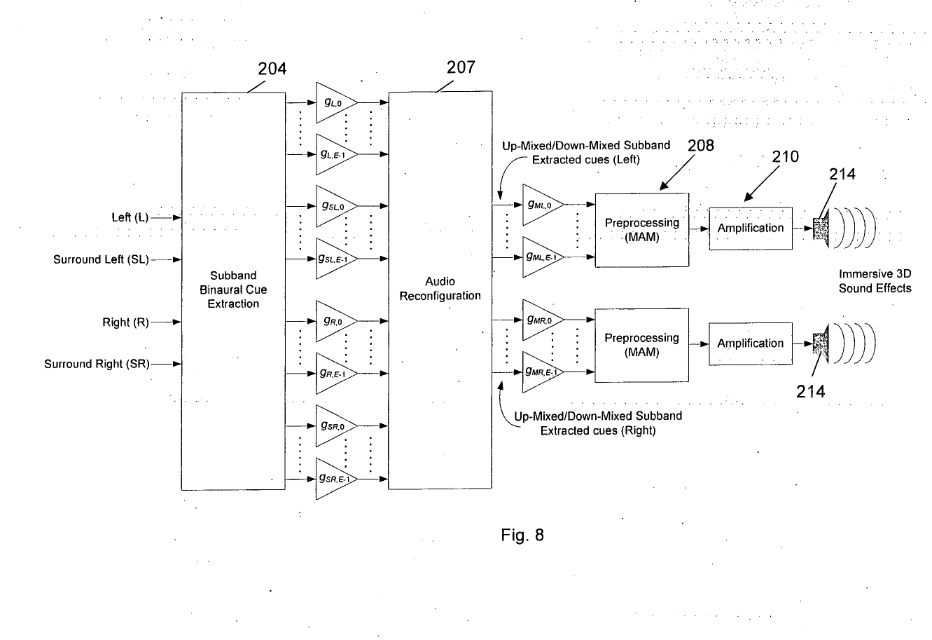

FIG. 8 illustrates an example of using a sub-band approach in the cue sending path of processing system 201. In this example, the input signal 202 comprises four channels (left, surround left, right, surround right) and each channel of the input signal 202 comprises a plurality of frequency bands, each frequency band of each channel being processed independently through the binaural cue extraction module 204, the pre-processing module 208 and the amplification module 210. In FIG. 8, cues are extracted from the left, surround left, right and surround right channels of the input signal 202. More specifically, the binaural cue extraction module 204 is configured to extract a sub-group of cues from each frequency band in each channel. A portion of each extracted sub-group of cues is then sent to the AR module 207 for reconfiguration and then to the directional loudspeakers 214 for transmission. Each of these portions may be adjusted independently using the variables a g_{L,0}, g_{L,1}, . . . g_{L, E-1} for the left channel, g_{SL,0}, g_{SL,1}, . . . g_{SL, E-1} for the surround left channel, g_{R,0}, g_{R,1}, . . . g_{R,E-1} for the right channel and g_{SR,0}, g_{SR,1}, . . . g_{SR,E-1} for the surround right channel as shown in FIG. 8. E indicates the number of frequency bands and each of the variables g_{L,0}, g_{L,1}, . . . g_{L,E-1}, g_{SL,0}, g_{SL,1}, . . . g_{SL, E-1}, g_{R,0}, g_{R,1}, . . . g_{R,E-1} and g_{SR,0}, g_{SR,1}, . . . g_{SR,E-1} ranges from zero to one (not inclusive of zero). The extracted cues from the left and surround left channels are then down-mixed by the AR module 207 to form the left output channel (shown as “Up-Mixed/Down-Mixed Subband Extracted cues (Left)” in FIG. 8) whereas the extracted cues from the right and surround right channels are down-mixed by the AR module 207 to form the right output channel (shown as “Up-Mixed/Down-Mixed Subband Extracted cues (Right)” in FIG. 8). Note that depending on the number of channels in the input signal 202 and the number of directional loudspeakers 214 to be used, the AR module 207 may perform up-mixing (instead of down-mixing) of the extracted cues. The up-mixing or down-mixing for each frequency band may be performed independently in the AR module 207. The output from the AR module 207 is then adjusted using the variables g_{ML,0}, g_{ML,1}, . . . g_{ML,E-1} and g_{MR,0}, g_{MR,1}, . . . g_{MR,E-1} before it is input to the preprocessing module 208. For example, a portion of the output from the AR module 207 for each frequency band may be extracted and sent to the preprocessing module 208 whereby each portion may be independently adjusted using the variables g_{ML,0}, g_{ML,1}, . . . g_{ML,E-1} and g_{MR,0}, g_{MR,1}, . . . g_{MR,E-1}.

Most prior art systems are based on a single-band approach, whereby a single pre-processing method and modulation technique is applied to the entire frequency range of the input signal. However, different ultrasonic emitters comprised in different loudspeakers usually have different frequency responses that are preferably individually addressed in order to achieve an accurate reproduction of directional sound with minimum distortion. Hence, the sub-band approach is advantageous [2] since different loudspeakers may be employed for different frequency bands, with each frequency band processed differently to suit the respective loudspeaker. This helps to optimize the performance of each frequency band and in turn, helps to improve the performance of the audio system 200.

Furthermore, although the MAM technique may be used with both the sub-band and full-band approaches, the advantages of the MAM technique can be better exploited with the sub-band approach. As mentioned above, a higher order pre-distortion term in the MAM technique will achieve a greater amount of reduction in the distortion but will require a loudspeaker with a larger bandwidth (which is generally more expensive). The sub-band approach allows the use of different types of loudspeakers in the same system, thus allowing the use of cheaper loudspeakers with lower bandwidths for frequency bands which are less important. This in turn lowers the cost of the audio system 200.

In addition, using the sub-band approach, the input signal 202 may be down-sampled, thus lowering and varying the speed requirement for processing each frequency band and in turn lowering the speed requirement for processing the entire signal. This mixed-rate processing technique thus removes the need for high-end processors and instead, a low cost digital signal processor can be used to implement the processing system 200.

Also, more variations may be made to the processing system 201 using the sub-band approach (for example, the number of frequency bands, the processing technique for each frequency band etc. may be varied), allowing manufacturers of the processing system 201 and the audio system 200 to differentiate their products in terms of pricing and applications.

Integration of Processing System 201 with Different Types of Systems

The processing system 201 may be integrated with different types of systems having different loudspeaker configurations.

In one example, the input signal 202 is selected to have a configuration matching the loudspeaker configuration the processing system 201 is to be integrated with. In this example, the ambience sending path of the processing system 201 is configured to operate in the direct-through mode. In another example, the configuration of the input signal 202 does not match the loudspeaker configuration and the ambience sending path of the processing system 201 is configured to operate in the reconfiguration mode. As mentioned above, in the reconfiguration mode, the AR module 206 is operable to reconfigure the part of the input signal 202 comprising ambience sounds to match the configuration of the conventional loudspeakers 212 to be used for sending this part of the input signal 202. This may be performed without user intervention for example, by automatically detecting the configuration of the conventional loudspeakers 212 or with slight user intervention via a user interface (e.g. a screen) to input the configuration of the conventional loudspeakers 212 into the processing system 201. The term “automatic” is used in this document to mean that although human interaction may initiate a process, human interaction is not required while the process is being carried out.

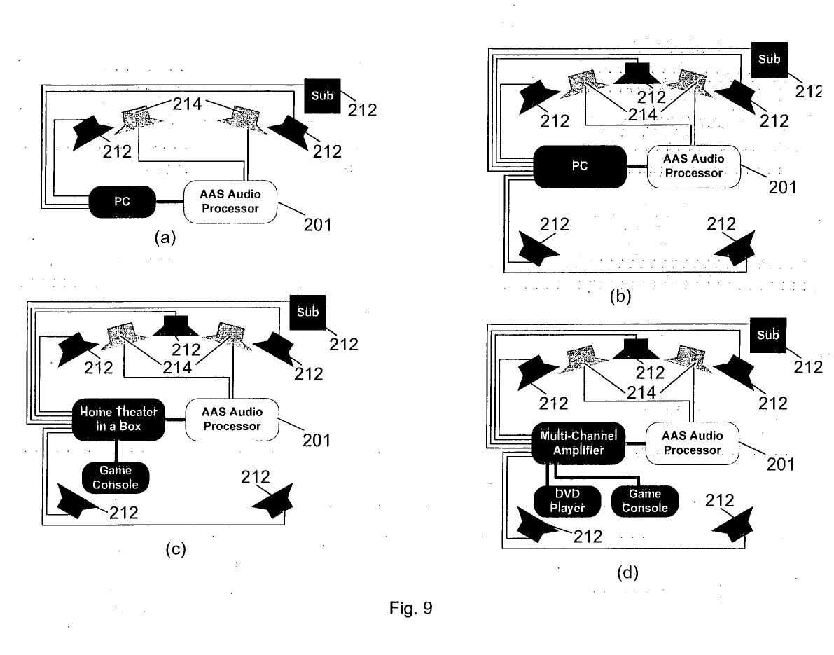

FIGS. 9(a)-(d) illustrate different examples of how the processing system (or AAS audio processor) 201 may be integrated with different systems having different loudspeaker configurations. In FIG. 9(a), the processing system 201 is integrated with a desktop PC with a stereo setup. In FIG. 9(b), the processing system 201 is integrated with a desktop PC with a multi-channel setup. In FIG. 9(c), the processing system 201 is integrated with a home theatre in a box (HTIB) system with multi-channel setup whereas in FIG. 9(d), the processing system 201 is integrated with a dedicated home theatre system with a multi-channel setup. In the setup shown in FIG. 9(d), the processing system 201 may be configured to extract and process binaural cues from multi-channel sources such as the game console and/or the DVD player (i.e. the input signal 202 comprises these multi-channel sources). Two sets of output, one comprising extracted binaural cues and the other comprising at least a part of the input signal 202 comprising ambience sounds) are, produced and are respectively sent to the directional loudspeakers 214 and the conventional loudspeakers 212. Although there is no restriction on where the directional loudspeakers 214 may be placed in the setups shown in FIGS. 9(a)-(d), it is preferable to place these directional loudspeakers 214 at locations where maximum directional projection to the user can be achieved.

The processing system 201 may further comprise a video tracking module which is configured to track the user's position and/or head movements. In one example, the audio system 200 further comprises a steering mechanism coupled with each of the directional loudspeakers 214 for steering the sound beam from the directional loudspeaker 214. The steering mechanism may comprise mechanical motors, electric motors and/or beam steering circuits and may be configured to cooperate with the video tracking module of the processing system 201 to steer the sound beams from the directional loudspeakers 214 according to the user's position and/or head movements. In one example, a small mechanical motor is built into each of the directional loudspeakers 214 and the directional loudspeakers 214 are rotated to face the user. Due to the highly directional nature of the sound beam from a directional loudspeaker, the sound beams from the loudspeakers 214 are thus directed to the user in this example.

The above-mentioned head-tracking feature of the audio system 200 is advantageous as it can present the same audio experience to the user regardless of the user's head movements. Furthermore, using this head-tracking feature, multiple sweet spots may be created to support a multi-listener auditory experience, providing the user with the same or similar audio experience at different locations.

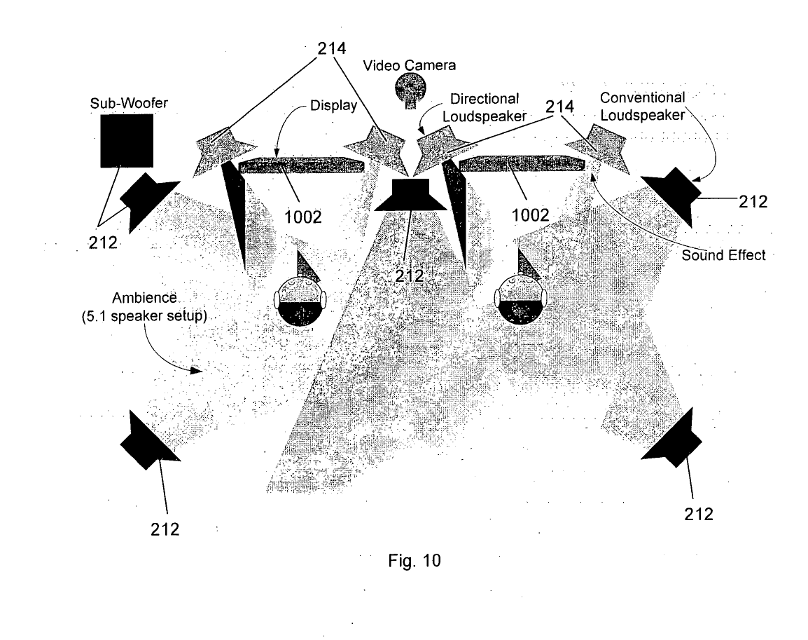

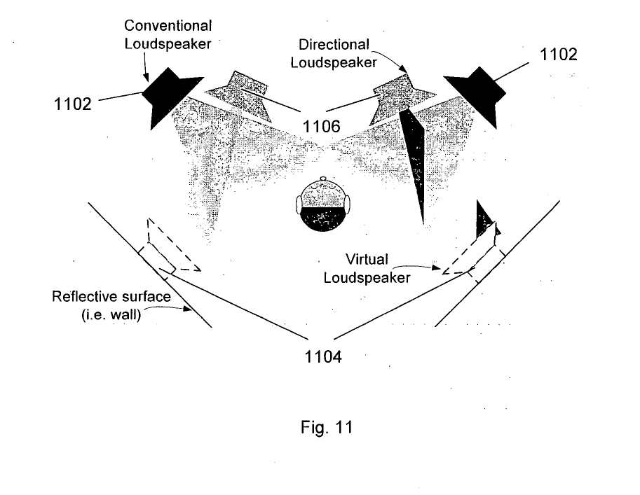

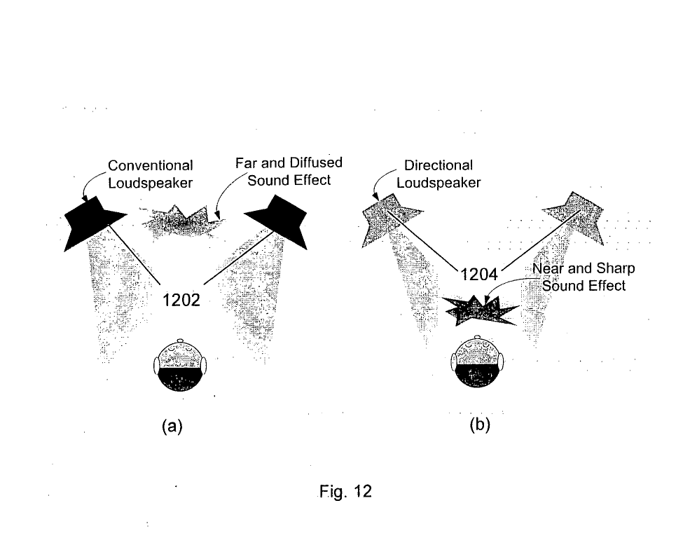

FIG. 10 illustrates an example setup of the conventional and directional loudspeakers 212, 214 and the video displays 1002. The conventional and directional loudspeakers 212, 214 may be coupled with the processing system 201. As shown in FIG. 10, each directional loudspeaker 214 is steered to face a user (a total of two users are shown in FIG. 10). This is in contrast to some prior art setups (for example, the setup disclosed in U.S. Pat. No. 6,229,899 as illustrated in FIG. 11). As shown in FIG. 11, U.S. Pat. No. 6,229,899 discloses a system whereby directional loudspeakers 1106 are arranged to face reflective objects (for example, a wall) in a room as they are configured to project sound beams against these reflective objects to form virtual loudspeakers 1104 at the points of reflection. These virtual loudspeakers 1104 may be used to replace surround loudspeakers in a surround sound system especially when it is difficult to install the surround loudspeakers. In the system shown in FIG. 11, a primary audio output is generated from the conventional loudspeakers 1102 whereas a secondary audio output is generated from the virtual loudspeakers 1104. The primary and secondary audio outputs may be the same and may be synchronized such that the listener hears a unified sound from multiple directions. As compared to the sound beams directed to the users in FIG. 10, reflected sound beams formed in prior art setups such as the one disclosed in U.S. Pat. No. 6,229,899 are usually weaker.

### Advantages of Audio System 200

The advantages of the audio system 200 are as follows.

In a multi-channel setup, the degree of audio imaging (mainly the sound effects) and the spaciousness provided by the audio sounds are usually dependent on the directivity (i.e. directional characteristic) of loudspeakers used in the setup. FIGS. 12(a) and (b) illustrate the audio images (i.e. sound effects) produced by loudspeakers having different directivities. In FIG. 12(a), loudspeakers 1202, each providing a wide dispersion of sound, are shown. The resulting sound effects from such loudspeakers 1202 usually lack sharpness in space due to the reverberant nature of the room acoustics. FIG. 12(b) shows loudspeakers 1204, each of which being fairly directional. The resulting sound effects from such loudspeakers 1204 usually lack spaciousness due to a lack of contribution from room acoustics. Thus, it is difficult to produce good audio effects using a setup with only one type of loudspeaker.

The audio system 200 employs both directional loudspeakers 214 and conventional loudspeakers 212, and thus is able to exploit both the directivity of directional loudspeakers and the wide dispersive characteristic of conventional loudspeakers. This helps to avoid the auditory spatial imaging issues, as discussed above with reference to FIG. 12. Thus, the audio system 200 is capable of delivering immersive sounds required by 3D games or other 3D media for example, 3D movies or TV.

The use of directional loudspeakers 214 in the audio system 200 is particularly advantageous. Transaural audio beam projection using an audio beam system (ABS) employing directional loudspeakers has been shown to be well suited for projecting 3D sound. Furthermore, studies based on several objective measurements and informal listening tests show that directional loudspeakers are not only useful for 3D sound projection, they can bring auditory spatial images closer to the listeners. It has also been shown that auditory spatial images are sharper and more vivid when directional loudspeakers are used. These enhancements in the auditory spatial images are highly desirable in 3D games, and provide garners with a more immersive gaming experience. The audio system 200 is hence advantageous since it exploits the strengths of directional loudspeakers 214 to enhance the auditory experience in for example, gaming and entertainment applications.

In particular, the directional loudspeakers 214 in the audio system 200 serve to transmit binaural cues selectively extracted from the audio channels of the input signal 202 whereas the conventional loudspeakers 212 serve to transmit the background audio image (i.e. the ambience sounds). The dispersive nature of the conventional loudspeakers 212 helps to recreate a certain degree of spaciousness and envelopment in the ambience sounds especially when more channels of the input signal 202 are used. The use of the directional loudspeakers 214 and the conventional loudspeakers 212 in this manner helps to create a highly-focused sound image comprising vivid auditory images close to the users while still projecting the background audio image to the users. In other words, the audio system 200 is able to provide both ambient effects (or surround sound effects) and sound depth reproduction. Thus, the audio system 200 is capable of achieving better auditory depth in for example, gaming and movie viewing as compared to conventional surround sound systems.

The selective extraction of binaural cues for transmission via the directional loudspeakers 214 is advantageous as compared to prior art systems such as the one disclosed in U.S. Pat. No. 6,229,899 (as illustrated in FIG. 11). In U.S. Pat. No. 6,229,889, the channels of the input signal transmitted via the directional loudspeakers 1106 may also comprise isolated audio effects not in the channels transmitted via the conventional loudspeakers 1102. However, these channels transmitted via the directional loudspeakers 1106 may also comprise a large amount of ambience sounds. Since the system in U.S. Pat. No. 6,229,899 is not configured to extract the audio effects from the mixture of audio effects and ambience sounds in these channels, the audio effects heard by a listener using the system in U.S. Pat. No. 6,229,899 tend to be not as sharp as the binaural cues heard by a listener using the audio system 200. Furthermore, the interoperability of system 200 is higher as compared to the system in U.S. Pat. No. 6,229,899. For example, the system in U.S. Pat. No. 6,229,899 can only work with an input signal having a number of channels equal to the number of loudspeakers. The audio effects and ambience sounds also have to be pre-distributed accordingly among the channels of this input signal so that each loudspeaker in the system of U.S. Pat. No. 6,229,899 receives the desired sound for transmission. On the other hand, the system 200 comprising both conventional and directional loudspeakers 212, 214 can work even with an input signal having a single channel (though, such an input signal is not preferable). In addition, regardless of how cues and ambience sounds are distributed among the channels of the input signal, the input signal can be used with the system 200. This is because the system 200 is configured to selectively extract binaural cues for transmission via directional loudspeakers 214 and is further configured to send ambience sounds to conventional loudspeakers 212 for transmission.

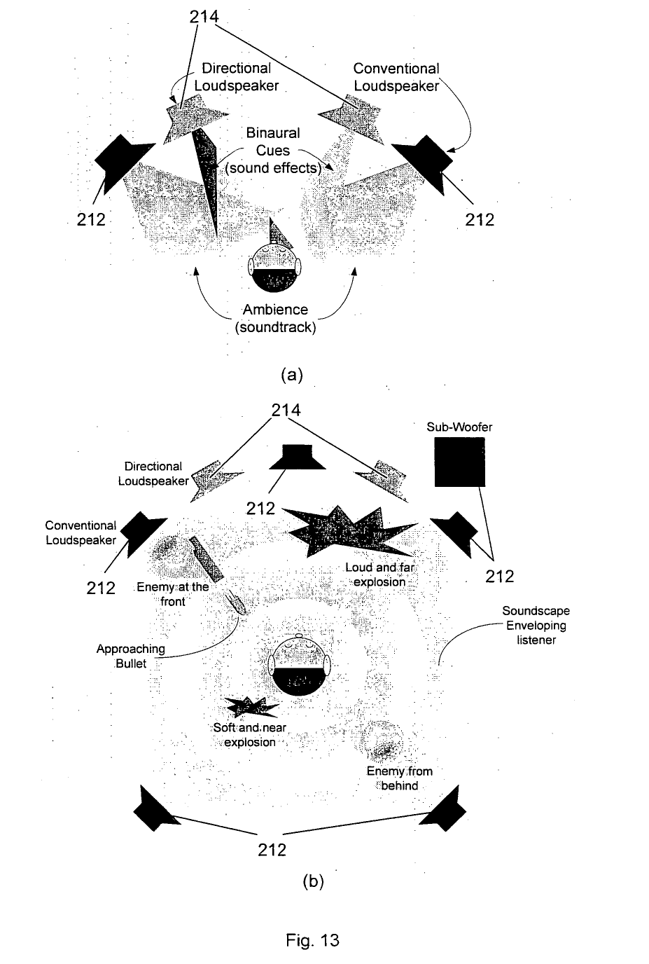

FIGS. 13(a)-(b) illustrate examples of soundscapes that may be achieved by the audio system 200. In FIG. 13(a), the audio system 200 comprises two conventional loudspeakers 212 and two directional loudspeakers 214 whereas in FIG. 13(b), the audio system 200 comprises a plurality of conventional loudspeakers 212 in a 5.1 surround sound system and two directional loudspeakers 214. In FIG. 13(b), an enveloping soundscape is created using the 5.1 surround sound system and the soundscape is further enhanced using the directional loudspeakers 214. The setup in FIG. 13(b) allows the developer of the audio system 200 to adjust the closeness of the sound effects to the user while maintaining an enveloping soundscape surrounding the user. As shown in FIGS. 13(a)-13(b), due to the use of both conventional loudspeakers 212 and directional loudspeakers 214, the soundscapes achieved by the audio system 200 are highly immersive.

Furthermore, in the processing system 201, binaural cues may be subtracted from the input signal 202 to extract the part of the input signal 202 to be sent to the conventional loudspeakers 212 for transmission. This is advantageous as it prevents the resultant audio output from being over-processed due to the over-emphasis of cues (since extracted cues are already transmitted via the directional loudspeakers 214). This advantage applies especially when down-mixing of the part of the input signal to be sent to the conventional loudspeakers 212 is performed.

In addition, the processing system 201 may be integrated with a user's existing surround loudspeaker system without replacing the surround loudspeakers with directional loudspeakers. Furthermore, the processing system 201 is configured such that it can be integrated with almost any loudspeaker configuration. Hence, it is capable of enhancing the audio output of many systems with different loudspeaker configurations (which may comprise stereo channels or multiple channels). Furthermore, as shown in FIG. 9, the processing system 201 can be integrated with both systems implementing low end applications (for example, desktop PC or notebooks) and systems implementing high end applications (for example, home theatre systems).

Furthermore, the processing system 201 employs the MAM technique which helps to overcome the high distortion normally found in the audio output of directional loudspeakers. In addition, the audio system 200 may be implemented using a sub-band approach whose advantages have been discussed above. The audio system 200 may also be implemented using a multi-channel approach whereby each channel of the input signal 202 is configured to be processed independently. Hence, each channel of the input signal 202 can employ a different loudspeaker and/or a different processing technique optimized for the channel.

The audio system 200 is also advantageous as compared to prior art systems such as the virtual surround sound system (VSSS) which uses 3D sound techniques to create a virtual sound image. Using the VSSS often results in a lack of auditory depth. In contrast, the audio system 200 achieves good auditory depth and creates vivid auditory images close to the users, hence adding a new dimension in sound projection that is currently not found in most other commercial systems.

The high definition graphics in today's gaming platforms have brought a new level of realism to garners. Due to the above advantages, the audio system 200 is able to enhance the level of realism in these gaming platforms by providing them with surround and accurate audio projection. This is crucial in completing the gaming experience. Furthermore, many of the current (and probably, next generation) interactive games, such as the widely popular Wii games, Kinect for XBOX360 and Move controller for Playstation 3, require users to interact with items or characters in the games via body movements. These gaming products are usually designed for a group of garners (may be up to 4 gamers) within close proximity to one other. However, even though these gaming products emphasize on the interactive multi-player gaming experience, it is difficult to deliver personalized audio information to each gamer. The audio system 200 can be used to solve this problem as it is capable of delivering personalized cues/sound effects to each gamer via the directional loudspeakers 214. Thus, it can enhance the interactive multi-player gaming experience and allows two or more garners within close proximity to have a co-operative gaming session without the need for headphones. The garners are thus able to communicate directly with each other and problems (such as fatigue) related to prolonged usage of headphones may be avoided.

The following summarizes a few key advantages provided by the audio system 200:

1. The sound effects produced by the audio system 200 are closer to the user as compared to many prior art systems. These sound effects are also sharp and highly accurate. Despite this, the audio system 200 is still able to provide sufficient spaciousness and envelopment for ambience sounds through the conventional loudspeakers 212.
2. The audio system 200 removes the need for headphones and thus, is not faced with problems associated with the use of headphones, for example, in-the-head problems and front-back confusion problems.
3. The processing system 201 of the audio system 200 may be integrated with different loudspeaker configurations as it comprises an AR module 206 which is operable to reconfigure its input to match the configuration of the conventional loudspeakers 212.

Furthermore, the audio system 200 may be used in a variety of commercial applications. These applications include for example:
(a) Augmenting the sound effects in gaming and movie applications using the directional loudspeakers 214; and
(b) Incorporating 4D viewing in omni-theatre applications

The audio system 200 may also be used for making sound systems, consumer electronics and various products in the entertainment industry.

### Variations

Further variations are possible within the scope of the invention as will be clear to a skilled reader.

For example, although the processing system 201 in FIG. 2 comprises only one cue extraction module 204, the number of cue extraction modules in the system 201 may be varied. For example, system 201 may comprise an additional cue extraction module along the ambience sending path (either before or after the AR module 206) to extract a further set of binaural cues from the input signal 202. This further set of binaural cues may or may not be the same as the set of binaural cues extracted by the cue extraction module 204. At least a portion of this further set of binaural cues may then be subtracted from the input signal 202 to form the part of the input signal 202 comprising ambience sounds. The same applies for the number of reconfiguration modules in the system 201. Similarly, although only two directional loudspeakers 214 are present in FIG. 2, there may be only one or more than two directional loudspeakers 214 in the audio system 200 (Note that it is however preferable to have at least two directional loudspeakers 214). The number of conventional loudspeakers 212 in the audio system 200 may also be different from that shown in FIG. 2.

### REFERENCES

[1] Avendano, C. and Jot, J.-M. “Ambience extraction and synthesis from stereo signals for multi-channel audio up-mix”; ICASSP, 2002
[2] PCT application PCT/SG2010/000312 “A Directional Sound System”

1. A processing system for processing an input signal to produce three-dimensional audio effects, the processing system comprising:
a cue sending path configured to extract a set of binaural cues from the input signal and further configured to send at least a portion of the extracted set of binaural cues to at least one directional loudspeaker for transmission; and
an ambience sending path configured to send at least a part of the input signal comprising ambience sounds to at least one conventional loudspeaker for transmission.

2. A processing system according to claim 1, wherein the ambience sending path comprises an ambience extraction unit configured to subtract from the input signal at least a portion of the extracted set of binaural cues to extract the part of the input signal comprising ambience sounds.

3. A processing system according to claim 2, wherein the portion of the extracted set of binaural cues to be subtracted from the input signal is adjustable.

4. A processing system according to claim 1, wherein the portion of the extracted set of binaural cues to be sent to the at least one directional loudspeaker is adjustable.

5. A processing system according to claim 1, wherein the cue sending path comprises a cue extraction module configured to extract the set of binaural cues from the input signal.

6. A processing system according to claim 5, wherein the processing system is coupled with a plurality of conventional loudspeakers comprising surround loudspeakers and non-surround loudspeakers; and
wherein the ambience sending path is configured to send at least a portion of the extracted set of binaural cues to the surround loudspeakers for transmission and is further configured to send the part of the input signal comprising ambience sounds to the non-surround loudspeakers for transmission.

7. A processing system according to claim 1, wherein the ambience sending path is operable in a plurality of modes comprising:
a reconfiguration mode in which the ambience sending path is operable to reconfigure the part of the input signal comprising ambience sounds to match a configuration of the at least one conventional loudspeaker before sending the part of the input signal comprising ambience, sounds to the at least one conventional loudspeaker; and
a direct-through mode in which the ambience sending path is configured to send the part of the input signal comprising ambience sounds directly to the at least one conventional loudspeaker.

8. A processing system according to claim 1, wherein the ambience sending, path comprises a reconfiguration module operable to reconfigure the part of the input signal comprising ambience sounds to match a configuration of the at least one conventional loudspeaker.

9. A processing system according to claim 8, wherein the cue sending path further comprises a further reconfiguration module operable to reconfigure the portion of the extracted set of binaural cues to be sent to the at least one directional loudspeaker, to match a configuration of the at least one directional loudspeaker.

10. A processing system according to claim 1, wherein the cue sending path further comprises, a pre-processing module configured to modulate the portion of the extracted set of binaural cues to be sent to the at least one directional loudspeaker, the pre-processing module employing a modulation technique which uses a pre-distortion term with a variable order.

11. A processing system according to claim 1, wherein the input signal comprises a plurality of channels and at least a part of the cue sending path is configured to process each channel of the input signal independently.

12. A processing system according to claim 11, wherein the cue sending path is configured to extract a group of binaural cues from each of one or more channels of the input signal and is further configured to send at least a portion of each extracted group of binaural cues to the at least one directional loudspeaker.

13. A processing system according to claim 12, wherein the portion of each extracted group of binaural cues to be sent to the at least one directional loudspeaker is independently adjustable.

14. A processing system according to claim 1, wherein the input signal comprises a plurality of channels and at least a part of the ambience sending path s configured to process each channel of the input signal independently.

15. A processing system according to claim 14, wherein the ambience sending path is configured to subtract from each of one or more channels of the input signal, at least a portion of a group of binaural cues extracted from the channel.

16. A processing system according to claim 15, wherein the portion of each group of binaural cues to be subtracted from the respective channel of the input signal is independently adjustable.

17. A processing system according to claim 1, wherein the input signal comprises a plurality of frequency bands and at least a part of one or both of the cue sending path and the ambience sending path is configured to process each frequency band independently.

18. A processing system according to claim 1, wherein the input signal comprises a plurality of channels, each channel comprising a plurality of frequency bands; and
wherein at least a part of one or both of the cue sending path and the ambience sending path is configured to process each frequency band of each channel independently.

19. A processing system according to claim 1, further comprising a video tracking module configured to track one or both of a user's position and the users head movements.

20. An audio system comprising:
a processing system for processing an input signal to produce three-dimensional audio effects according to claim 1;
at least one directional loudspeaker configured to receive the portion of the extracted set of binaural cues for transmission; and
at least one; conventional loudspeaker configured to receive the part of the input signal comprising ambience sounds for transmission.

21. An audio system according to claim 20, wherein the processing system further comprises a video tracking module configured to track one or both of a user's position and the user's head movements, the audio system further comprising:
a steering mechanism configured to cooperate with the video tracking module of the processing system for steering a sound beam from the at least one directional loudspeaker according to one or both of the user's position and the user's head movements.

22. A method for processing an input signal to produce three-dimensional audio effects, the method comprising the steps of:
extracting a set of binaural cues from the input signal and sending at least a portion of the extracted set of binaural cues to at least one directional loudspeaker for transmission; and
sending at least a part of the input signal comprising ambience sounds to at least one conventional loudspeaker for transmission.
